(19) United States
(12) Patent Application Publication
(10) Pub. No.: US 2009/0325429 A1
(43) Pub. Date: Dec. 31, 2009

(54) ENERGY CAPTURE METHOD AND APPARATUS

(76) Inventor: Barry McNew, Cottonwood, AZ (US)

Correspondence Address: Kunzler & McKenzie, 8 EAST BROADWAY, SUITE 600, SALT LAKE CITY, UT, 84111, US

(21) Appl. No.: 12/477,045

(22) Filed: Jun. 2, 2009

Related U.S. Application Data
(60) Provisional application No. 61/058,130, filed on Jun. 2, 2008.

(51) Int. Cl. B63H 21/17; B60L 11/00; H01M 8/00

(52) U.S. Cl. 440/6; 429/12

(57) ABSTRACT

An apparatus, system, and method are disclosed for an apparatus, system, and method to capture and store energy created as a result of a solid object moving through an electrolyte. The apparatus, in one embodiment includes a solid material, an electrolyte, a propulsion mechanism and an electrode. In certain embodiments the propulsion mechanism configured to produce a propulsive force to drive the solid material through the electrolyte at a rate sufficient to produce a net electrical charge on the solid material. The electrode may be connected to the solid material and configured to conduct the electrical charge away from the solid material.

### CROSS-REFERENCES TO RELATED APPLICATIONS

This application claims priority to U.S. Provisional Patent Application No. 61/058,130 entitled “Energy Capture Method and Apparatus” and filed on Jun. 2, 2008 for Barry McNew.

### BACKGROUND OF THE INVENTION

1. Field of the Invention

The present invention relates generally to a method and apparatus for capturing and retaining energy created through any of the following energy producing phenomena: the rotation of a driveshaft or similar rotating shaft in seawater, galvanic interactions of various metals comprising a boats driveshaft or other metallic components in seawater, energy created at the solid-fluid interface through electrokinetics or other energy created as a result of a solid material moving through seawater.

2. Description of the Related Art

The present invention has been developed as a result of observations made with respect to boats and other fast moving objects in seawater. As a boat or other object travels over or through the seawater, fluorescent material can be viewed in its wake.

Fluorescence occurs where external energy is absorbed by a fluorescent material and immediately remitted. This phenomena is the result of a molecule or quantum dot relaxing to its ground state after being electronically excited. The excitation stage of a fluorescent process can be expressed according to the formula Sₒ+hv→S₁. Where h is Plank's constant and v is the frequency of light. In this equation the fluorescent material absorbs electronic energy and is excited to a higher energy state as represented by S₁. In the excited stage, photons are emitted according to the formula S₁→S₀+hv as the fluorescent material relaxes to its ground state S₀.

The energy required to raise the fluorescent material contained within seawater is the result of energy producing phenomena such as the rotation of driveshaft, galvanic interactions between metals comprising the driveshaft and other metallic components on the boat, electrical currents created at the solid-fluid interface through electrokinetic interactions as well as other energy producing phenomena. Currently this energy is wasted as no method or apparatus has heretofore been invented to collect and store the energy. It is an objective of the present invention to provide a power-generating device which utilizes existing energy sources which is wasted in contemporary boats, automobiles and other mobile devices.

### SUMMARY OF THE INVENTION

From the foregoing discussion, it should be apparent that a need exists for an apparatus, system, and method to capture and store energy created as a result of a solid object moving through an electrolyte.

The present invention has been developed in response to the present state of the art, and in particular, in response to the problems and needs in the art that have not yet been fully solved by currently available energy capture and storage devices. Accordingly, the present invention has been developed to provide an apparatus, system, and method for capturing and storing energy created as a result of a solid object moving through an electrolyte that overcomes many or all of the above-discussed shortcomings in the art.

The apparatus, in one embodiment includes a solid material, an electrolyte, a propulsion mechanism and an electrode. In certain embodiments the propulsion mechanism configured to produce a propulsive force to drive the solid material through the electrolyte at a rate sufficient to produce a net electrical charge on the solid material. The electrode may be connected to the solid material and configured to conduct the electrical charge away from the solid material.

In one embodiment the solid material includes at least one surface in contact with the electrolyte at an interface. In certain embodiments the interface between the solid material and the electrolyte creates an electrical double layer that includes a first layer of ions and a second layer of ions. The first layer of ions may be disposed on the at least one surface of the solid material with the second layer of ions disposed adjacent to the first layer of ions. In one embodiment the propulsive force drives the solid material through the electrolyte at a rate sufficient to displace at least one ion in the second layer of ions. In certain embodiments the displacement of the ions creates a net electrical charge on the solid material.

In a further embodiment, the solid material may include pores sized to receive an ion. The propulsive force driving the solid material through the electrolyte may also drive the solid material at a rate sufficient to force at least one ion through a pore in the solid material. In certain embodiments, the pores have a first end and a second end with the first end disposed adjacent to the at least one surface of the solid material. Thus, in certain embodiments that the first layer of ions with a first polarity are disposed adjacent to the first end of the plurality of pores. The at least one ion that is driven through the pore in the solid material may have an opposite polarity than the first polarity. Thus, in certain embodiments an electric potential may result between the first end and the second end of the plurality of pores. In one embodiment the solid material may be non-conductive so that the electrical potential is maintained between the first end and the second end of the pores.

In one embodiment the solid material is a hull of a boat that is driven through the electrolyte at a rate that is sufficient to displace the ions and produce a net electrical charge on the hull of the boat. In another embodiment the solid material may be a driveshaft rotated at a high enough speed to displace the ions and produce a net electrical charge on the driveshaft. In certain embodiment the device may include a container to hold the electrolyte while a driveshaft is rotated within the container.

The apparatus, in certain embodiments, may include an electrical storage device coupled to the electrodes. The electrical storage device may be included to store the electrical charge.

A method of the present invention is also presented for capturing and storing energy created as a result of a solid object moving through an electrolyte. The method in the disclosed embodiments substantially includes the steps necessary to carry out the functions presented above with respect to the operation of the described apparatus and system. In one embodiment, the method includes placing a solid material in an electrolyte, forcing the solid material through the electrolyte at a rate sufficient to displace at least one ion and conducting a resulting electrical charge from the solid material. In certain embodiments the surface of the solid material and the electrolyte create an electrical double layer having a first layer of ions on the surface of the solid material with a second layer of ions next to the first layer of ions.

In certain embodiments, the method may also include creating an electrical potential by forcing an ion through a pore in the solid material. The pore may be sized to allow only ions having a polarity opposite the polarity of the ions on the surface of the solid resulting in ions of one polarity on one side of the pore and ions of an opposite polarity on the other side of the pore. In one embodiments the method also includes storing the electrical charge in an electrical storage device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages of the present invention will become more fully apparent from the following description, or maybe learned by the practice of the invention as set forth hereinafter.

### BRIEF DESCRIPTION OF THE DRAWINGS

In order that the advantages of the invention will be readily understood, a more particular description of the invention will be rendered by reference to specific embodiments illustrated in the appended drawings, which depict only the typical embodiments of the invention and are not to be considered limiting of its scope, in which:

FIG. 1 is a side elevational view of one embodiment of a driveshaft electrolyte container combination according to the present invention;

FIG. 2 is a side cross-sectional view of the driveshaft electrolyte container combination according to the present invention;

FIG. 3 is a top plan view of a driveshaft contained within a sheath embodiment of the present invention;

FIG. 4 is a cross-sectional view taken along line 206 of FIG. 3;

FIG. 5 is a cross-section view of the sheath 200 of FIG. 3 and FIG. 4;

FIG. 6 is a side elevational view of a solid-fluid interface embodiment of the present invention in which a electric double layer is shown at the solid fluid interface.

FIG. 7 is a schematic flow chart diagram illustrating one embodiment of a method for for capturing and storing energy created as a result of a solid object moving through an electrolyte in accordance with the present invention

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided to impart a thorough understanding of embodiments of the invention. One skilled in the relevant art will recognize, however, that the invention may be practiced without one or more of the specific details, or with other methods, components, materials, and so forth. In other instance, well known structures, materials, or operations are not shown or described in detail to avoid obscuring aspects of the invention.

The present invention is directed to capturing and storing the energy causing the fluorescence. In its simplest embodiment, in an automobile application, for example, the invention would consist of placing a container of seawater around the rotating driveshaft, with energy from the driveshaft entering the seawater for later delivery and/or storage. Electrodes connected to the container of seawater are used to carry the current generated to a chargeable batter or other electrical storage apparatus.

In another embodiment, the apparatus comprises a driveshaft and sheath constructed of metals close together on the galvanic series, with the sheath being highly conductive material. One example would be a stainless steel shaft with a copper sheath. The stationary sheath surrounds the rotating driveshaft at a sufficient distance to allow for free rotation of the driveshaft and to hold a functional quantity of an electrolytic solution, such as seawater.

The electrolytic solution occupies the space between the shaft and the sheath. In a marine application the sheath may be open at the ends or elsewhere to the passage of fluid. In a land or freshwater application (Automobile, fresh-water boat) the sheath would be sealed around the shaft to contain the electrolytic solution. Lead wires connected to the conducting sheath might be used to carry the current generated to a chargeable battery or other electrical storage apparatus.

In this embodiment, a sacrificial metal higher on the galvanic series, such as zinc, may be removably attached in physical contact with the inside surface of the conducting sheath. The sacrificial metal replaces the “zincs” currently in use in boating applications to spare the working parts of the propulsion system from corrosion.

In a further embodiment a magnet may be attached to the shaft such that it rotates in relation to the stationary sheath and augments the generation of current.

In a further embodiment electrical current resulting from water traveling over the surface of the boat or other solid object. When water travels over a surface, the ions that it is made up of rub against the solid, leaving the surface slightly charged. The present invention captures and stores this charge.

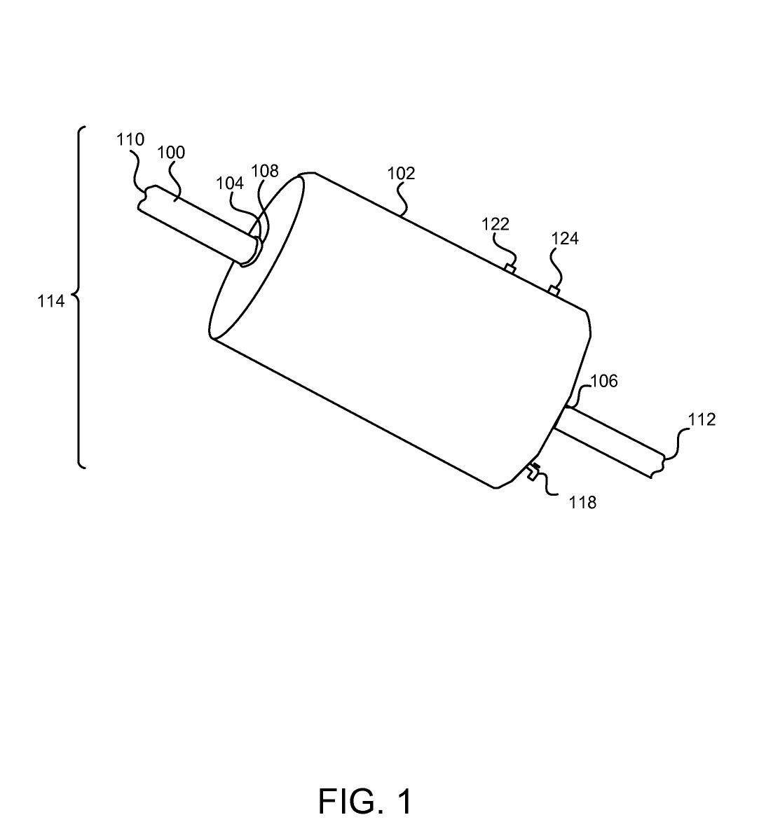

FIG. 1 illustrates a side elevational view of one embodiment of the present invention. The driveshaft electrolyte container combination 114 comprises a driveshaft 100, as is known in the art, which is encapsulated in container 102. The driveshaft 100 extends through openings 104 and 106 in the container 102.

The proximal end 110 of the driveshaft 100 is connected to a rotational producing mechanism (not shown) such as a transmission, engine or other rotational device as is known in the art. The distal end 112 of the driveshaft 100 is connected to the driving force of the vehicle such as the wheels or propeller (not shown) as is known in the art. Alternatively, the distal end 112 of the driveshaft 100 may be unattached such that it spins freely.

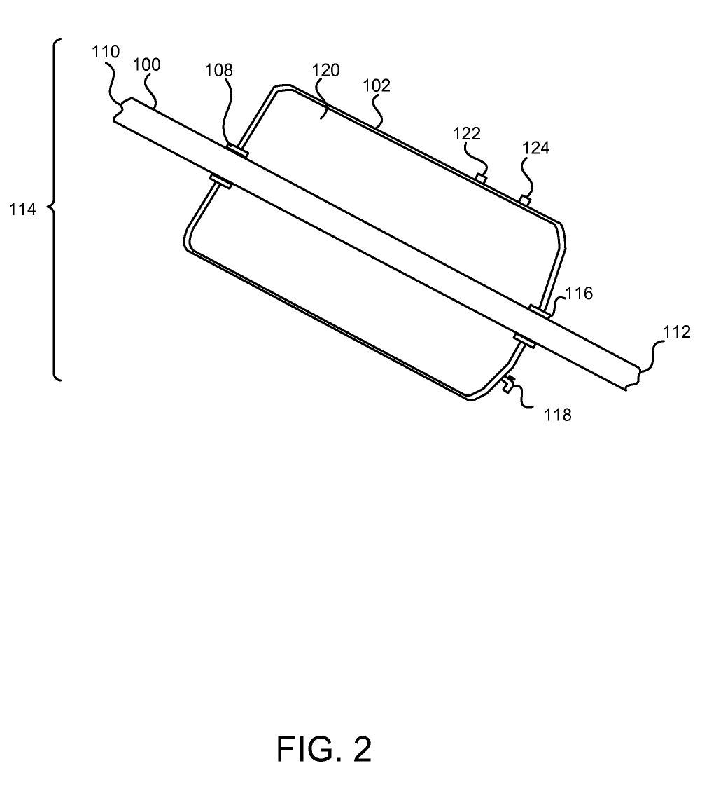

Turning now to FIG. 2 a cross-sectional view of the driveshaft electrolyte container combination 114 is shown. Driveshaft 100 is rotationally affixed within container 102 such that the driveshaft may rotate within the container. Seals 108 and 116 create a fluid-tight seal between the driveshaft 100 and the container 102.

The container 102 and driveshaft 100 are sealed by seals 108 and 116 which create a reservoir 120 for the containment of seawater or other electrolyte. A valve 118 may be affixed to the container 102 in such a way as to allow the contents of the reservoir 120 to be drained and refilled for the replacement of contaminated seawater or other electrolyte.

In operation, the driveshaft 110 spins within the container 102 containing seawater or other electrolyte creating a current. Lead wires (not shown) connected to electrodes 122 and 124 provide a current carrying means for charging a battery for storage or immediate use.

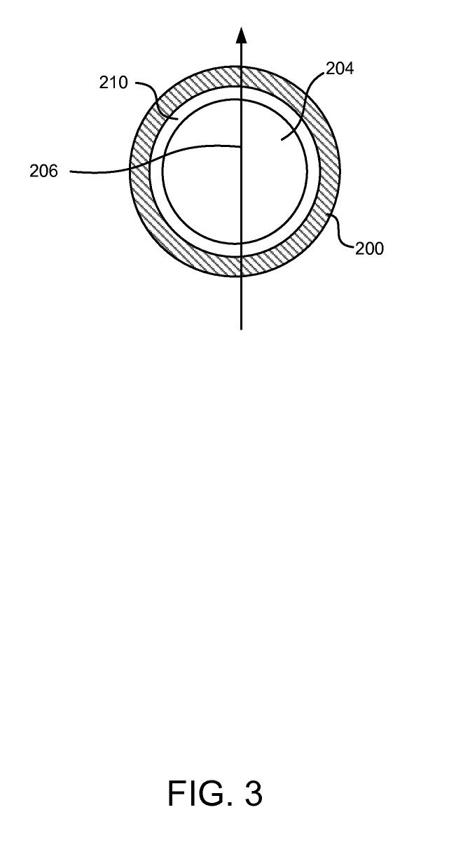

Another embodiment of the present invention is shown in FIG. 3 which shows a top plan view of a driveshaft 204 encased in a sheath 200. In this embodiment of the present invention the sheath 200 is constructed from a highly conductive material, such as copper. The sheath 200 remains stationary and surrounds the rotating driveshaft 204 at a sufficient distance to allow for free rotation of the driveshaft and to hold a functional quantity of an electrolytic solution, such as seawater.

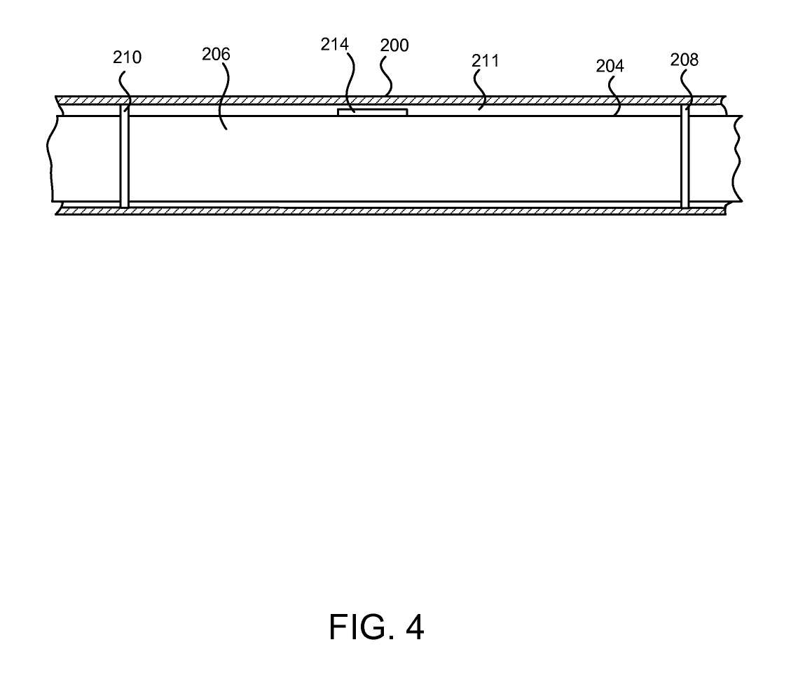

Turning now to FIG. 4, a cross-sectional view of the apparatus taken along line 206 is shown. In a freshwater or dry land embodiment of the current invention, the sheath 200 is sealed against the driveshaft 204 by use of seals 208 and 210. Seals 208 and 210 create a compartment 211 for the containment of an electrolyte such as seawater. In a saltwater environment such as that found on the ocean, the sheath may be open at the ends or elsewhere to permit the passage of fluid.

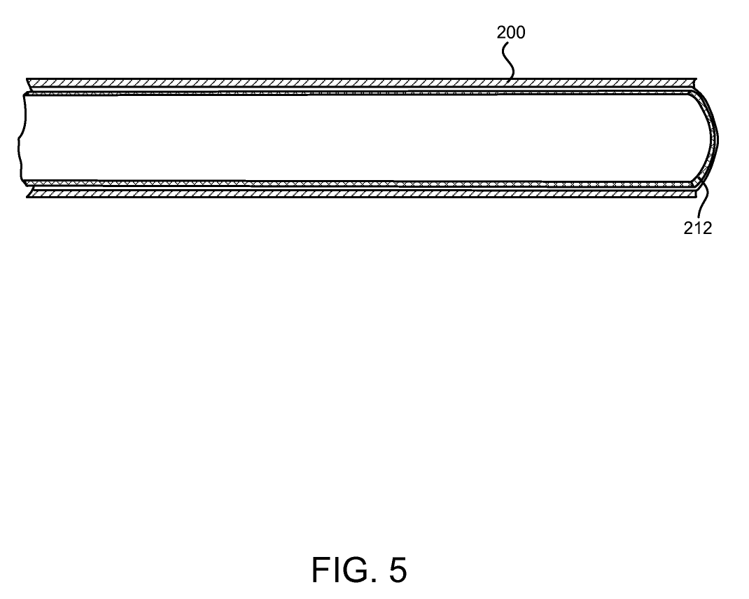

In another embodiment, shown in FIG. 5, a sleeve 212 comprising a sacrificial metal higher on the galvanic series, such as zinc, may be removably attached in physical contact with the inside surface of the conducting sheath 200. The sacrificial metal replaces the “zincs” currently in use in boating applications to spare the working parts of the propulsion system from corrosion. In yet another embodiment of the current invention, the sleeve 212 is comprised of magnetic material to augment the creation of a current.

In operation the sheath 200 or sleeve 212 (if one is used) and driveshaft 204 are in direct contact and are comprised of dissimilar metals with differing electrical potentials. Sea water acts as a common electrolyte which will conduct electricity. The metal components of the present invention create voltages or potentials by the liberation of metal ions into solution. The ions flow through the metal from high potential to low potential in an effort to reach equilibrium. This creates a current which can then be stored in a battery or other storage device or used immediately.

Movement of electrolyte with respect to the active electrode, in this case the sheath 200 or sleeve 212, improves the efficiency of a battery by carrying away depleted electrolyte and any impurities which may have been found therein. The rotation of the driveshaft 204 creates turbulence within the sheath 200 which washes away depleted electrolyte. Fins 214 of FIG. 4 may be added to the driveshaft 204 to increase turbulence and more effectively wash away depleted electrolyte.

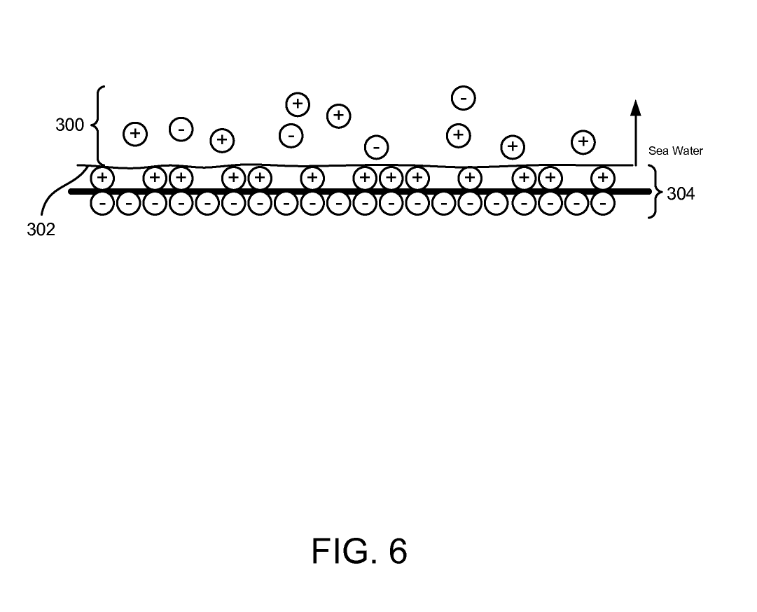

In another embodiment of the current invention shown in FIG. 6 the solid-fluid interface 302 of a boat hull 304 and seawater is shown. At the point of contact between a solid and a fluid, some of the atoms in the solid disassociate, forming positive ions and free, negative electrons. In FIG. 6 dissociated ions and electrons 300 are shown in the seawater. Depending on the material of the boat hull either the electrons or the positive ions will dissociate and flow into the fluid, in this case seawater. The boat hull 304 shown in FIG. 6 has a net negative charge, however, it is understood that this is dependent on the solid material comprising the boat hull 304. If the boat hull 304 is non-conductive, the charge remains at the surface attracting oppositely charged ions and repelling negatively charged ions in the seawater. This forms an electric double layer along the interface of the boat hull 304 and seawater.

As the boat moves along the surface of the seawater the fluid is forced through pores and channels in the solid material. Only the attracted type fluid ions move through the pores, ions with the same charge as the surface of the solid are repelled from the channel. This flow of ions results in a separation of fluid charges on either side of the pores and channels which creates an electrical potential between the two ends. Lead wires connected to electrodes provide a current carrying means for charging a battery for storage or immediate use.

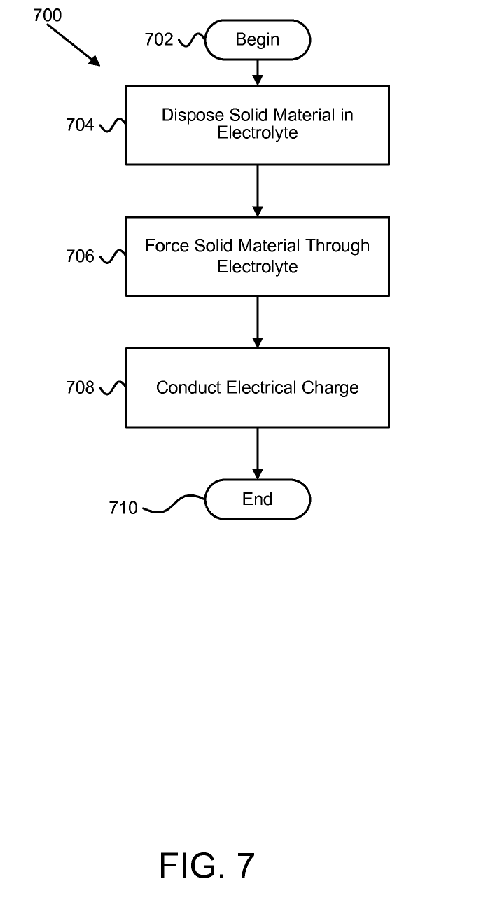

FIG. 7 illustrates a method 700 for capturing and storing energy created as a result of a solid object moving through an electrolyte. The method 700 begins 702 and a solid material is disposed in an electrolyte. In certain embodiments the solid material has at least one surface and the solid material and the electrolyte create an electrical double layer having a first layer of ions on the surface of the solid material. A second layer of ions may be disposed on or adjacent to the first layer of ions. The solid material is forced 704 through the electrolyte at a rate sufficient to displace at least one ion from the second layer of ions. This displacement produces a net electrical charge on the solid material. The electrical charge may be conducted 706 away from the solid material for use elsewhere and the method ends 710.

In one embodiment the method may also include creating an electrical potential by forcing the ions through pores in the solid material to accumulate ions of opposite polarities on each side of the pores. This results in an electrical potential on each side of the pores. In certain embodiments the method may also include storing the conducted electrical charge in an electrical storage device such as a battery.

The invention may be embodied in other specific forms without departing from the spirit of the essential characteristics thereof. The present embodiments, therefore, are to be considered in all respects as illustrative and are not restrictive, and all changes which come within the meaning and range of equivalency of the claims are therefore intended to be embraced therein.

What is claimed is:

1. an apparatus to produce and retrieve electric energy, the apparatus comprising:
a solid material;
an electrolyte;
a propulsion mechanism connected to the solid material, the propulsion mechanism configured to produce a propulsive force to drive the solid material through the electrolyte, the solid material driven through the electrolyte at a rate sufficient to produce a net electrical charge on the solid material; and
an electrode connected to the solid material and configured to conduct the electrical charge from the solid material.

2. The apparatus of claim 1, wherein the solid material comprises at least one surface in contact with the electrolyte at an interface, the interface between the solid material and the electrolyte creating an electrical double layer, the electrical double layer comprising a first layer of ions on the at least one surface of the solid material and a second layer of ions disposed adjacent to the first layer of ions, wherein the propulsive force drives the solid material through the electrolyte at a rate sufficient to displace at least one ion in the second layer of ions.

3. The apparatus of claim 2, wherein the first layer of ions has a first polarity and the second layer of ions has a second polarity, wherein the first polarity and the second polarity comprise opposite polarities such that the displacement of at least one ion in the second layer of ion creates a net electrical charge on the solid material.

4. The apparatus of claim 3, wherein the solid material comprises a plurality pores, the plurality of pores sized to receive an ion, wherein the propulsive force driving the solid material through the electrolyte drive the solid material at a rate sufficient to force at least one ion through a pore in the solid material.

5. The apparatus of claim 4, wherein the at least one ion forced through the pore has a polarity opposite the polarity of the first layer of ions such that the first layer of ions attracts the at least one ion forced through the pore.

6. The apparatus of claim 5, wherein the first layer of ions repel ions having a same polarity as the polarity of the first layer of ions such that an ion having the same polarity as the first polarity of the first layer of ions is repelled from the at least one pore.

7. The apparatus of claim 4, wherein the plurality of pores comprise a first end and a second end, the first end disposed adjacent to the at least one surface of the solid material such that the first layer of ions having the first polarity are disposed adjacent to the first end of the plurality of pores, wherein the at least one ion driven through the pore in the solid material comprises an opposite polarity than the first polarity such that an electric potential results between the first end and the second end of the plurality of pores.

8. The apparatus of claim 1, wherein the solid material is non-conductive.

9. The apparatus of claim 8, wherein the solid material comprises a hull of a boat, wherein the hull of the boat is driven through the electrolyte at a rate sufficient to displace at least one ion in an electrical double layer to produce a net electrical charge on the hull of the boat.

10. The apparatus of claim 1, wherein the solid material comprises a driveshaft, wherein the driveshaft is rotated at a speed sufficient to displace at least one ion in an electrical double layer to produce a net electrical charge on the driveshaft.

11. The apparatus of claim 10, further comprising a container configured to hold the electrolyte, wherein the driveshaft is rotated within the container.

12. The apparatus of claim 1, further comprising an electrical storage device coupled to the at least one electrode, the electrical storage device configured to store electrical charge.

13. An apparatus to produce and retrieve electric energy, the apparatus comprising:
a solid material comprising at least one surface;
an electrolyte in contact with the at least one surface at an interface, the interface between the solid material and the electrolyte creating an electrical double layer comprising a first layer of ions on the at least one surface of the solid material and a second layer of ions disposed adjacent to the first layer of ions;
a propulsion mechanism connected to the solid material, the propulsion mechanism configured to produce a propulsive force to drive the solid material through the electrolyte, the solid material driven through the electrolyte at a rate sufficient to displace at least one ion in the second layer of ions such that the solid material has a net electrical charge on the at least one surface; and
an electrode connected to the solid material and configured to conduct the electrical charge from the solid material.

14. The apparatus of claim 13, wherein the solid material comprises a plurality of pores sized to receive an ion, wherein the propulsive force driving the solid material through the electrolyte drive the solid material at a rate sufficient to force at least one ion in the second layer of ions through a pore in the solid material.

15. The apparatus of claim 14, wherein the plurality of pores comprise a first end and a second end, the first end disposed adjacent to the at least one surface of the solid material such that the first layer of ions having the first polarity are disposed adjacent to the first end of the plurality of pores, wherein the at least one ion driven through the pore in the solid material comprises an opposite polarity than the first polarity such that an electric potential results between the first end and the second end of the plurality of pores.

16. The apparatus of claim 13, wherein the solid material comprises a hull of a boat, wherein the hull of the boat is driven through the electrolyte at a rate sufficient to displace at least one ion in the electrical double layer to produce a net electrical charge on the null of the boat.

17. The apparatus of claim 13, wherein the solid material comprises a driveshaft, wherein the driveshaft is rotated at a speed sufficient to displace at least one ion in an electrical double layer to produce a net electrical charge on the driveshaft.

18. A method to produce and retrieve electric energy, the method comprising:
placing a solid material comprising at least one surface in an electrolyte, the solid material and the electrolyte creating an electrical double layer comprising a first layer of ions on the at least one surface of the solid material and a second layer of ions disposed adjacent to the first layer of ions;
forcing the solid material through the electrolyte at a rate sufficient to displace at least one ion in the second layer of ions, the displacement of the at least one ion producing a net electrical charge on the solid material; and
conducting the electrical charge from the solid material.

19. The method of claim 18, further comprising creating an electrical potential by forcing the at least one ion through a pore in the solid material, wherein the at least one ion driven through the pore in the solid material comprises an opposite polarity than a polarity of the first layer of ions such that an electric potential results between a first end and a second end of the pore.

20. The method of claim 18, further comprising storing the conducted electrical charge in an electrical storage device.
